(19) United States
(12) Patent Application Publication
(10) Pub. No.: US 2018/0326602 A1
(43) Pub. Date: Nov. 15, 2018

(54) Hair trimming apparatus

(71) Applicants: Anand Khubani, Towaco, NJ (US); Eric Langberg, Milford, PA (US); Aaron Szymanski, Morristown Thomaston, CT (US)

(72) Inventors: Anand Khubani, Towaco, NJ (US); Eric Langberg, Milford, PA (US); Aaron Szymanski, Morristown Thomaston, CT (US)

(21) Appl. No.: 15/932,888

(22) Filed: May 15, 2018

Related U.S. Application Data
(60) Provisional application No. 62/506,312, filed on May 15, 2017.

(51) Int. Cl. B26B 19/06; B26B 19/46; B26B 19/38; F21V 23/04

(52) U.S. Cl. CPC B26B 19/063; B26B 19/46; F21V 23/04; B26B 19/3846; B26B 19/3886; B26B 19/3873

(57) ABSTRACT

The present invention provides for a hair trimming apparatus having a pivotally attached blade cartridge with a blade that is insert-molded to a jacket and has a rear surface that is etched.

### RELATED APPLICATION

This application is based on and claims priority from the provisional application entitled “HAIR TRIMMING APPARATUS” with U.S. Ser. No. 62/506,312 filed on May 15, 2017.

### BACKGROUND OF THE INVENTION

### Field of the Invention

This invention relates to a hair trimming apparatus and more specifically, to an apparatus having a pivotally attached blade cartridge with a blade that is insert-molded to a jacket and has a rear surface that is etched.

### SUMMARY OF THE INVENTION

In one embodiment, the present invention relates to a hair trimming apparatus comprising: a housing having opposing ends, a first bottom end forming a handle and a second top end comprising an agitator; a head attached to the top end of the housing; and a blade cartridge pivotally attached to the head, and the blade cartridge comprises at least one blade and an agitator receiver, and the agitator is connected to the agitator receiver and in a use position, the agitator moves the blade allowing for trimming of a user's hair.

In another embodiment, the head covers at least a portion of the agitator. In yet another embodiment, the blade cartridge further comprises at least two blades and at least one jacket. In still another embodiment, the first blade has a rear surface that is etched. In still yet another embodiment, the first blade is insert-molded with the jacket.

In a further embodiment, the jacket comprises at least one post and the second blade comprises at least one hole for receiving the post. In another further embodiment, the blade cartridge further comprises at least one spring, at least one plate and at least one spring fixer which are received by the post, and the plate maintains space between the first and second blades. In another embodiment, the blade cartridge further comprises at least one spring, at least one plate and at least one spring fixer which are received by the post, and the plate evenly distributes pressure from the spring on the first and second blades.

In yet another further embodiment, the apparatus further comprises at least one button for activating trimming action and wherein the housing has an exterior surface, and the button is situated on the exterior surface of the housing.

In still another further embodiment, the apparatus further comprises at least one light. In yet another embodiment, the light is situated on an exterior surface of the housing. In still yet another further embodiment, the button also activates the light.

In another embodiment, the apparatus further comprises at least one motor attached to at least one transmission. In still another embodiment, the agitator is attached to the transmission. In yet another embodiment, the agitator receiver is centrally located on a rear side of the blade cartridge.

In still another embodiment, there is an axis of rotation formed by the blade cartridge and the top end of the housing. In yet another embodiment, the axis of rotation is located about the center of the rear surface of the blade cartridge.

In a further embodiment, the present invention relates to a hair trimming apparatus comprising: a housing having opposing ends, a first bottom end forming a handle and a second top end; and a blade cartridge pivotally attached to said top end of said housing, said blade cartridge comprises at least two blades and at least one jacket, a first blade is insert molded into the jacket, and the jacket comprises at least one post and a second blade comprises at least one hole for receiving the post, and the blade cartridge further comprises at least one spring, at least one plate and at least one spring fixer which are received by the post, and the plate maintains space between the first and scone blades.

In a further embodiment, the apparatus further comprises at least one agitator for moving the blades. In yet a further embodiment, at least one blade has an etched surface. In still a further embodiment, the apparatus further comprises at least one motor attached to a transmission. In still yet a further embodiment, the agitator is attached to the transmission.

In another embodiment, the apparatus further comprises at least one light. In a further embodiment, the apparatus further comprises at least one button for activating the agitator and the light. In yet a further embodiment, a portion of the agitator protrudes from the top end of the housing. In still a further embodiment, the blade cartridge further comprises at least one agitator receiver for receiving the agitator.

In a further embodiment, there is an axis of rotation formed by the blade cartridge and the top end of the housing and the axis of rotation is located about the center of the rear surface of the blade cartridge.

### BRIEF DESCRIPTION OF THE DRAWINGS

The accompanying drawings are included to provide a further understanding of the present invention. These drawings are incorporated in and constitute a part of this specification, illustrate one or more embodiments of the present invention and together with the description, serve to explain the principles of the present invention.

FIG. 1 is an explode view of the blade cartridge;

FIG. 2 is a perspective view of hair trimming apparatus with a head attached;

FIG. 3 is a perspective view of the hair trimming apparatus without a head attached; and

FIG. 4 is a perspective view of the hair trimming apparatus without a head.

Among those benefits and improvements that have been disclosed, other objects and advantages of this invention will become apparent from the following description taken in conjunction with the accompanying drawings. The drawings constitute a part of this specification and include exemplary embodiments of the present invention and illustrate various objects and features thereof.

### DETAILED DESCRIPTION OF THE INVENTION

As required, detailed embodiments of the present invention are disclosed herein; however, it is to be understood that the disclosed embodiments are merely exemplary of the invention that may be embodied in various forms. The figures are not necessarily to scale, some features may be exaggerated to show details of particular components. Therefore, specific structural and functional details disclosed herein are not to be interpreted as limiting, but merely as a basis for the claims and as a representative basis for teaching one skilled in the art to variously employ the present invention.

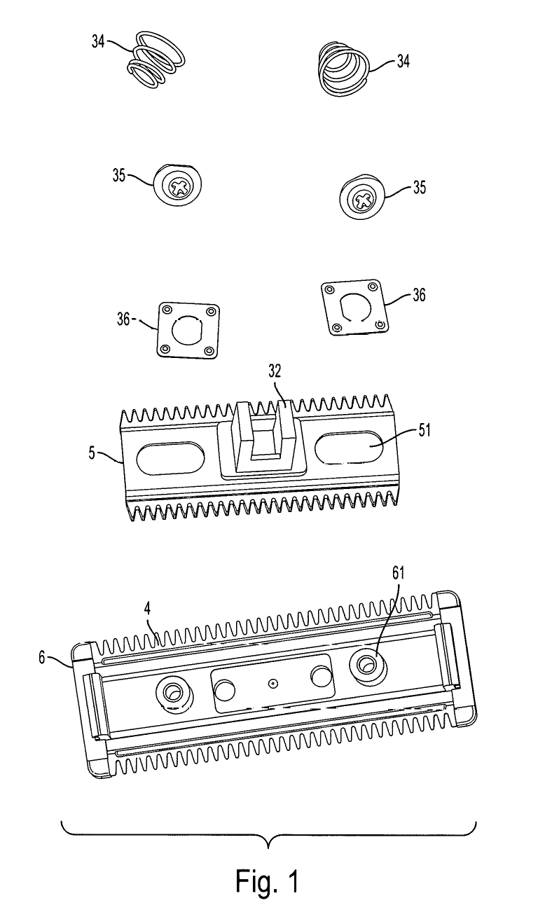

FIG. 1 illustrates an exploded view of the blade cartridge 3. The figure illustrates springs 34, spring fixers 35, and plates 36 which are received on posts 61 of jacket 6 of first blade 4. The Figure further illustrates second blade 5 with holes 51 which posts 61 run through. The figure further illustrates agitator receiver 32 of second blade 5. The blade cartridge 3 is made for a movable stacked arrangement. The second blade 5 is designed to be placed on top of the first blade 4. The holes 51 on the second blade 5 are designed to be received by the posts 61 of first blade 4. The holes 51 have a length that is greater than the diameter of the posts 61, this allows the second blade 5 to reciprocate to create a cutting action. The second blade 5 is secured in position adjacent the first blade 4 by blade fixers 35 that use springs 34 and plates 36 to create the optimal tension between the blades for the most effective cutting action. The agitator receiver 32 receives the agitator 14 to create the actual motion for the cutting action.

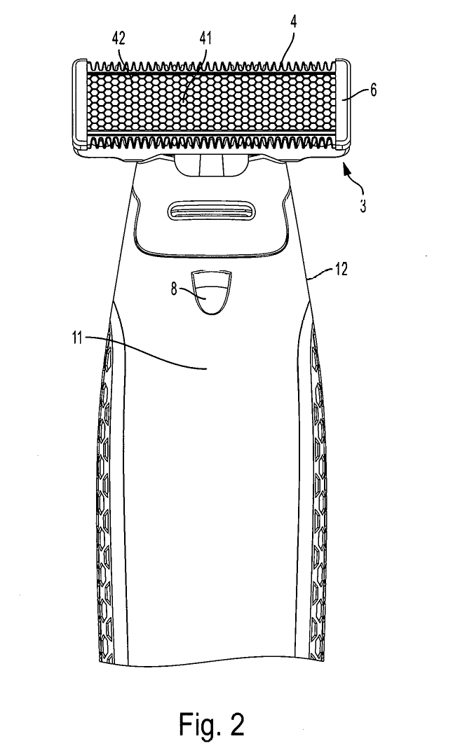

FIG. 2 illustrates the hair trimming apparatus having a blade cartridge 3 attached to the first end (handle) 12. The figure further depicts the blade cartridge 3, showing the first blade 4 with a rear surface 41 having an etching (or etched surface) 42 and the jacket 6. The figure further illustrates the housing 1 having an exterior surface 11 and a light 8. The light 8 provides illumination for the area that the hair trimming apparatus is being used. The etching 42 on the rear surface 41 provides for smooth movement over a user's skin.

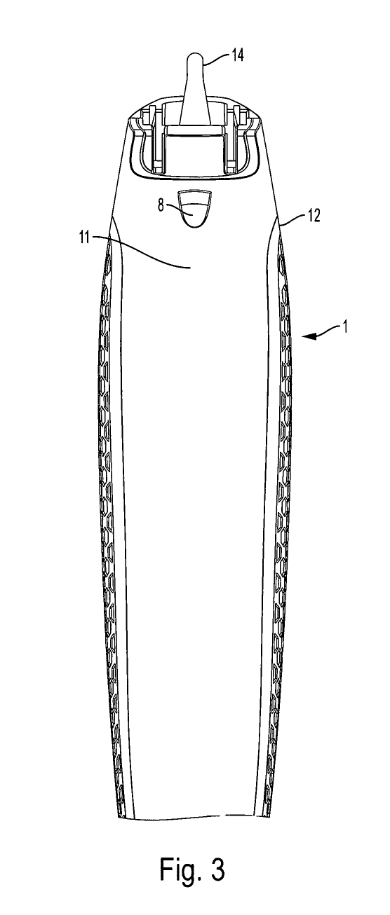

FIG. 3 illustrates the hair trimming apparatus with housing 1 without a head or blade cartridge 3 attached. The figure shows the agitator 14, light 8, and exterior surface 11 of the housing at the first end 12. The housing 1 has a mostly hollow internal cavity (not shown). The internal cavity of the housing contains a power source (not shown) that is connected to a motor (not shown) and a transmission (not shown) that is connected to and drives the agitator 14. The motor is also connected to circuitry and wire that link it to the button 7, the button 7 allows a user to turn the device on and off. The internal housing further contains a power source (not shown) that can be a disposable or rechargeable battery. The power source provides the energy to operate the motor, the motor and power source are connected to one another.

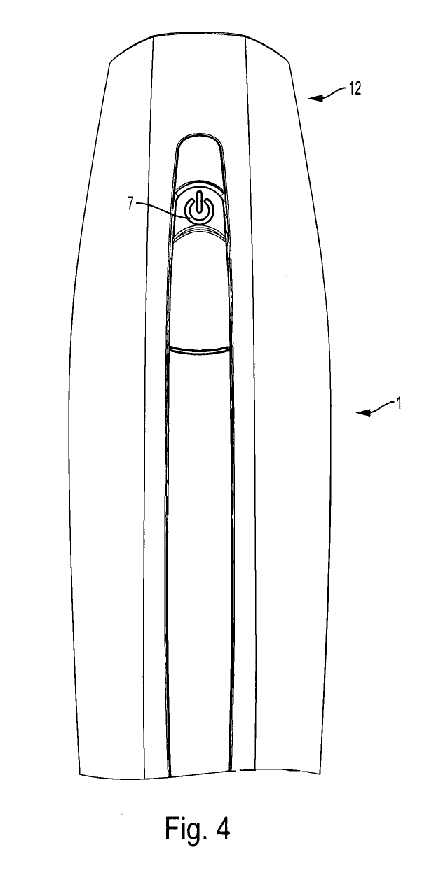

FIG. 4 illustrates the hair trimming apparatus with housing 1 without a head attached. The figure shows a button 7 that is at the first end (handle) 12 of the housing 1. The button 7 is linked to internal circuitry and wire that allow the user to power the hair trimming apparatus on and off.

Numerous modifications and variations of the present invention are possible in light of the above teachings. It is therefore to be understood that within the scope of the attendant claims attached hereto, this invention may be practiced otherwise than as specifically disclosed herein.

What is claimed is:

1. A hair trimming apparatus comprising:
a housing having opposing ends, a first bottom end forming a handle and a second top end comprising an agitator;
a head attached to said top end of said housing; and
a blade cartridge pivotally attached to said head, said blade cartridge comprises at least one blade and an agitator receiver, said agitator being connected to said agitator receiver and in a use position, said agitator directly moves said blade allowing for trimming of a user's hair.

2. The apparatus of claim 1 wherein said head covers at least a portion of said agitator.

3. The apparatus of claim 1 wherein said blade cartridge further comprises at least two blades and at least one jacket.

4. The apparatus of claim 3 wherein said first blade has a rear surface that is etched.

5. The apparatus of claim 4 wherein said first blade is insert molded with said jacket.

6. The apparatus of claim 5 wherein said jacket comprises at least one post and said second blade comprises at least one hole for receiving said post.

7. The apparatus of claim 6 said blade cartridge further comprises at least one spring, at least one plate and at least one spring fixer which are received by said post, said plate maintains space between said first and second blades.

8. The apparatus of claim 6 said blade cartridge further comprises at least one spring, at least one plate and at least one spring fixer which are received by said post, said plate evenly distributes pressure from said spring on said first and second blades.

9. The apparatus of claim 1 further comprises at least one button for activating trimming action and wherein said housing has an exterior surface, said button is situated on said exterior surface of said housing.

10. The apparatus of claim 9 further comprises at least one light.

11. The apparatus of claim 10 wherein said light is situated on an exterior surface of said housing.

12. The apparatus of claim 10 wherein said button also activates said light.

13. The apparatus of claim 1 further comprises at least one motor attached to at least one transmission.

14. The apparatus of claim 13 wherein said agitator is attached to said transmission.

15. The apparatus of claim 1 wherein said agitator receiver is centrally located on a rear side of said blade cartridge.

16. The apparatus of claim 1 wherein there is an axis of rotation formed by said blade cartridge and said top end of said housing.

17. The apparatus of claim 16 wherein said axis of rotation is located about the center of said rear surface of said blade cartridge.

18. A hair trimming apparatus comprising:
a housing having opposing ends, a first bottom end forming a handle and a second top end; and
a blade cartridge pivotally attached to said top end of said housing, said blade cartridge comprises at least two blades and at least one jacket, a first blade is insert molded into said jacket, said jacket comprises at least one post and a second blade comprises at least one hole for receiving said post, said blade cartridge further comprises at least one spring, at least one plate and at least one spring fixer which are received by said post, said plate maintains space between said first and second blades.

19. The apparatus of claim 18 further comprises at least one agitator for moving said blades.

20. The apparatus of claim 18 wherein at least one blade has an etched surface.

21. The apparatus of claim 18 further comprising at least one motor attached to a transmission.

22. The apparatus of claim 19 wherein said agitator is attached to said transmission.

23. The apparatus of claim 18 further comprises at least one light.

24. The apparatus of claim 23 further comprises at least one button for activating said agitator and said light.

25. The apparatus of claim 19 wherein a portion of said agitator protrudes from said top end of said housing.

26. The apparatus of claim 19 wherein said blade cartridge further comprises at least one agitator receiver for receiving said agitator.

27. The apparatus of claim 18 wherein there is an axis of rotation formed by said blade cartridge and said top end of said housing.

28. The apparatus of claim 27 wherein said axis of rotation is located about the center of said rear surface of said blade cartridge.
